(19) United States
(12) Patent Application Publication
(10) Pub. No.: US 2006/0108285 A1
(43) Pub. Date: May 25, 2006

(54) Nozzle for collecting extracted material

(75) Inventors: Masao Bounoshita, Hachioji-shi (JP); Muneo Saito, Hachioji-shi (JP)

Correspondence Address: RANKIN, HILL, PORTER & CLARK, LLP, 925 EUCLID AVENUE, SUITE 700, CLEVELAND, OH, 44115-1405, US

(73) Assignee: Jasco Corporation, Hachioji-shi (JP)

(21) Appl. No.: 11/268,003

(22) Filed: Nov. 7, 2005

(30) Foreign Application Priority Data
Nov. 15, 2004 (JP) 2004-330113

(51) Int. Cl. B01D 11/04

(52) U.S. Cl. 210/634; 422/70; 210/198.2; 210/511

(57) ABSTRACT

A nozzle for collecting extracted material for efficiently collecting a solution sprayed, together with gas, from an exit-tube at the outlet of a backpressure control valve in a supercritical fluid chromatograph or a supercritical fluid extraction apparatus. A nozzle 10 is fitted to an end of and is used for collecting in a collection vessel a liquid component in a fluid supplied from the exit-tube. The nozzle 10 comprises a nozzle body 12, an exit-tube hole 18 provided in the nozzle body 10, an opening 14 provided at the lower end of the nozzle body 10, a filter 14 provided above the opening 14 in the nozzle body 10, and an exhaust hole 20 provided in the nozzle body 10 at a position above the filter 16. When the nozzle 10 is fitted, the downstream tip of the exit-tube is inserted through the exit-tube hole 18 and is secured so that the downstream tip of the exit-tube is almost in contact with the filter 14. The fluid discharged from the exit-tube is sprayed into the filter 14. The space enclosed by the filter 14 and the nozzle body 12 above the filter 14 is pressurized due to the gaseous component contained therein, and the liquid component passes through the filter 14 and is discharged from the opening 14.

### RELATED APPLICATIONS

This application claims priority to the Japanese Patent Application 2004-330113 dated on Nov. 15, 2004 and is hereby incorporated with reference for all purposes.

### BACKGOUND OF THE INVENTION

1. Field of the Invention

The present invention relates to nozzles for collecting extracted material, which are connected to an exit-tube downstream of a backpressure control valve in a supercritical fluid chromatograph or a supercritical fluid extraction apparatus, for collecting in a collection vessel a liquid component from fluid supplied from the exit-tube, and more particularly, to improvements thereof

2. Description of the Related Art

Supercritical fluid extraction (SFE) is a process used for separating various materials. A related technique, supercritical fluid chromatography (SFC), is used for separating and analyzing various materials. (For example, refer to Japanese Unexamined Patent Application Publication No. H2-194802.) In particular, techniques using supercritical carbon dioxide have several advantages over solvent extraction methods, including high extraction efficiency and the ability to easily perform post processing after refinement. Furthermore, because of their lower cost, non-toxic property, and the use of the material that is less harmful to the environment than organic solvents, such techniques are expected to find uses in a wide range of fields, even to replace preparative liquid chromatography.

Since a supercritical fluid is used under conditions above the critical temperature and the critical pressure, the apparatus must be designed to have a backpressure control valve at the downstream side of a column (in the case of SFC) or an extraction vessel (in the case of SFE). Since this backpressure control valve has a high pressure on one side and atmospheric pressure on the other side, compressed carbon dioxide or supercritical carbon dioxide becomes vaporized upon passing through the valve. As a result, liquid used as an entrainer (or modifier), is scattered and spurts out from an exit-tube at the outlet side of the backpressure control valve, together with the extracted or separated material. Under such conditions, there may be contamination between sample vessels for collecting individual fractions. Furthermore, a mist may be produced from the scattered liquid, and therefore, the effects of the extracted components on the health of the operator must also be taken into consideration.

Therefore, the following methods have been conventionally used for sorting and separating the extracted liquids.

(1) A method of preventing scattering by providing an additional space for a sealed system at the outlet of the backpressure control valve, disposing sample vessels in the space, and connecting another valve for taking the backpressure at the downstream side of the space in order to generate an under-pressure state.

(2) A method for generating an under-pressure state, when collecting a plurality of fractions, by providing a valve at the outlet of the backpressure control valve, sorting and separating the extracted liquids into sample vessels, and disposing each sample vessel in a sealed system like that described in (1) above.

(3) A method in which a valve is provided at the outlet of the backpressure control valve, the components are trapped in a collection column before being introduced into sample vessels, and then they are introduced into the sample vessels using a rinsing solution.

(4) A method in which the extracted fluid is introduced into a sample vessel, which is filled with liquid, and extracted material is collected in the liquid.

However, with methods (1) and (2), the system becomes large and complex, and the cost thus increases. With method (3), additional equipment such as a pump for supplying the rinsing solution is required, which increases the cost. With method (4), the problem of the liquid becoming scattered remains, as before, and this method is therefore not effective.

### SUMMARY OF THE INVENTION

The present invention has been conceived in light of the circumstances described above, and an object thereof is to provide a nozzle for collecting extracted material for efficiently collecting a solution sprayed, together with gas, from an exit-tube at the outlet of a backpressure control valve.

A nozzle for collecting extracted material acorrding to present invention is fitted to an end of an exit-tube at the downstream side of a backpressure control valve in a supercritical fluid chromatograph or a supercritical fluid extraction apparatus and is used for collecting in a collection vessel a liquid component in a fluid supplied from the exit-tube.

The nozzle of the present invention comprises: a nozzle body enclosing a space of predetermined volume; an exit-tube hole provided in the nozzle body, for inserting a downstream tip of the exit-tube into the nozzle body to secure the exit-tube; an opening provided at the lower end of the nozzle body, for discharging outside the nozzle body the liquid component in the fluid supplied from the exit-tube; a filter provided above the opening in the nozzle body; and an exhaust hole provided in the nozzle body at a position above the filter, for exhausting at a predetermined speed a gaseous component in the fluid supplied from the exit-tube to regulate the pressure in the space enclosed by the filter and the nozzle body above the filter. When the nozzle is fitted, the downstream tip of the exit-tube is inserted through the exit-tube hole and is secured so that the downstream tip of the exit-tube is almost in contact with the filter. The fluid discharged from the exit-tube is sprayed into the filter. The space enclosed by the filter and the nozzle body above the filter is pressurized due to the gaseous component contained therein, and the liquid component passes through the filter and is discharged from the opening.

The nozzle of the present invention comprises: a nozzle body enclosing a space of predetermined volume; an entry tube provided in the nozzle body and connected to the downstream tip of the exit-tube, for introducing the fluid supplied through the exit-tube into the nozzle body; an opening provided at the lower end of the nozzle body, for discharging outside the nozzle body the liquid component in the fluid supplied through the entry tube; a filter provided in the nozzle body above the opening so as to be almost in contact with the downstream tip of the entry tube; and an exhaust hole disposed above the filter, for exhausting at a predetermined speed a gaseous component in the fluid supplied through the entry tube to regulate the pressure in the space enclosed by the filter and the nozzle body above the filter. When the nozzle is fitted, the downstream tip of the exit-tube and the upstream tip of the entry tube are connected. The fluid from the exit-tube passes through the entry tube and is sprayed into the filter. The space enclosed by the filter and the nozzle body above the filter is pressurized due to the gaseous component contained therein, and the liquid component passes through the filter and is discharged from the opening.

In the nozzle of the present invention, it is preferable that the filter comprises a porous material, a woven-fiber filter, a mesh-like material, a set of layers of the mesh-like material, or a powdered substance.

In the nozzle of the present invention, it is preferable that the filter comprises one or more material selected from the group consisting of a porous sintered metal, glass wool, a minute spherical metal, polymer or silica gel powder, and a fine mesh-like metal.

In the nozzle of the present invention, it is preferable that the nozzle further comprises an exhaust-level regulator, provided in the exhaust hole, for regulating the exhaust level of the gaseous component.

According to a nozzle for collecting extracted material of the present invention, because a filter is placed immediately after the exit-tube outlet and the interior of the nozzle body is kept at a suitable pressure, it is possible to efficiently collect the liquid component without causing it to be scattered.

### BRIEF DESCRIPTION OF THE DRAWINGS

FIG. 1 is an outlined diagram of a supercritical fluid extraction apparatus.

FIGS. 2A and 2B are outlined diagrams of a nozzle for collecting extracted material according to a first embodiment of the present invention.

FIG. 3 is a diagram for explaining the operation of the nozzle for collecting extracted material according to the first embodiment of the present invention.

FIGS. 4A and 4B are diagrams explaining an example application of the nozzle for collecting extracted material according to the first embodiment shown in FIG. 2.

FIG. 5 is an outlined diagram of a nozzle for collecting extracted material according to a second embodiment of the present invention.

### DESCRIPTION OF THE PREFERRED EMBODIMENT

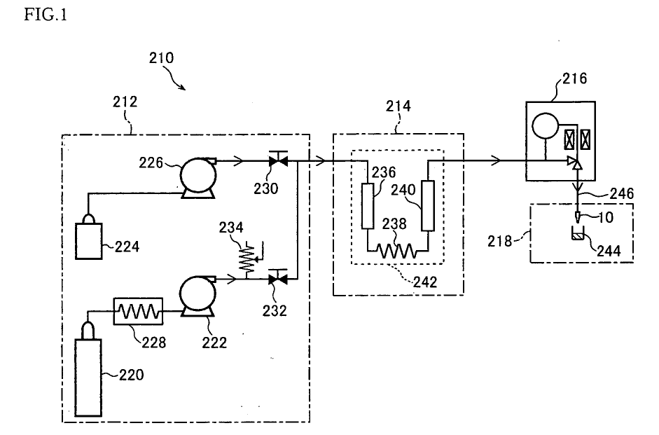

A nozzle for collecting extracted material according to the present invention is connected to an exit-tube at the downstream side (outlet) of a backpressure control valve in a supercritical fluid chromatograph or a supercritical fluid extraction apparatus in order to collect liquid-phase components from the fluid supplied from the exit-tube. First, a sketchy diagram of the structure of a general supercritical fluid extraction apparatus, serving as one example of an apparatus in which the nozzle for collecting extracted material according to the present invention can be used, is shown in FIG. 1. In the following description, it is assumed that carbon dioxide is used as the supercritical fluid and methanol is used as the entrainer. However, apparatuses that can use the nozzle according to the present invention are not limited to the apparatus described below.

A supercritical fluid extraction apparatus 210 shown in FIG. 1 includes a fluid supply system 212 for supplying supercritical fluid and an entrainer; an extraction system 214 for performing extraction using the supercritical fluid supplied from the fluid supply system 212; a backpressure control valve 216 provided downstream of the extraction system 214, for controlling the pressure in a tube; and a collection system 218 positioned downstream of the back pressure control valve 216, for recovering the extracted material.

The fluid supply system 212 includes a CO₂ cylinder 220, a CO₂′ supply pump 222 connected to the outlet of the CO₂ cylinder 220, a methanol tank 224, and a methanol supply pump 226 connected to the outlet of the methanol tank 224. Liquid carbon dioxide supplied from the CO₂ cylinder 220 passes through a pre-cooling coil 228 and is supplied under pressure to the extraction system 214 by the CO₂ supply pump 222. The outlet side of the methanol supply pump 226 is connected to the outlet tube of the CO₂ pump 222, to supply methanol to the extraction system 214 in the same way. Reference numerals 230 and 232 represent stop valves, and reference numeral 234 represents a safety valve.

The extraction system 214 includes an accumulator 236 for suppressing pressure changes inside the tubes and mixing the CO₂ and the methanol, a preheating coil 238, and an extraction vessel 240, which are all contained inside a temperature-controlled chamber 242. The preheating coil 238 heats the liquid carbon dioxide supplied from the fluid supply system 212 to the critical temperature or above in order to produce a supercritical fluid. The supercritical carbon dioxide is supplied to the extraction vessel 240, and after being subjected to a predetermined extraction operation, it is sent to the backpressure control valve 216.

The backpressure control valve 216 performs feedback control to keep the pressure in the tube constant by detecting the pressure in the tube supplying the supercritical carbon dioxide fluid, including the extracted material and the entrainer, and controlling the degree of opening of the valve.

An exit-tube 246 connected downstream of the backpressure control valve 216 extends towards the collection system 218. In the collection system 218, liquid components in the fluid supplied from the exit-tube 246 are collected in a collection vessel 244. A nozzle 10 for collecting extracted material according to an embodiment of the present invention is connected to the exit-tube 246 at the downstream side of the backpressure control valve 216. Nozzles for collecting extracted material according to preferred embodiments of the present invention will be described below with reference to the drawings.

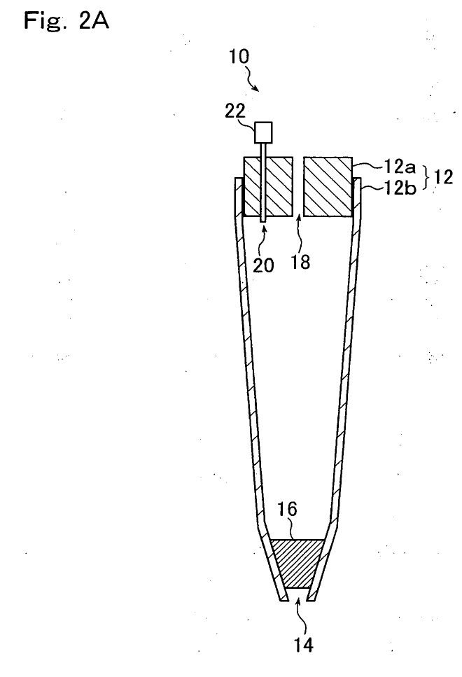

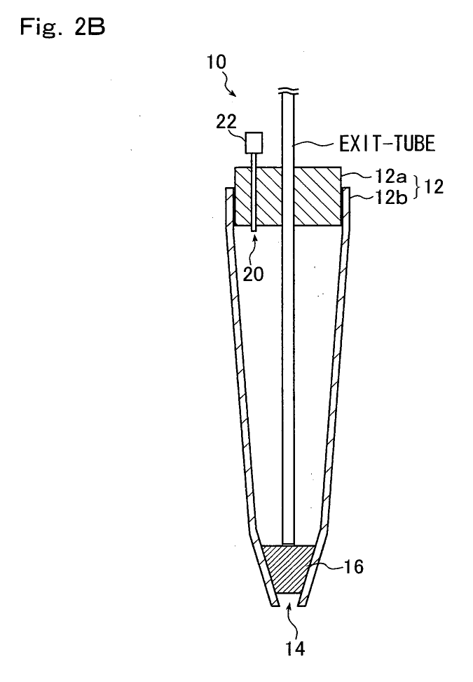

FIGS. 2A and 2B are partial cross-sections of the nozzle 10 for collecting extracted material according to a first embodiment of the present invention. FIG. 2A shows the nozzle 10 before fitting it to the exit-tube 246, and FIG. 2B shows the nozzle 10 fitted to the exit-tube 246. As shown in FIG. 2A, the nozzle 10 includes a nozzle body 12 defining a space of predetermined volume, an exit-tube hole 18 provided in the nozzle body 12, an opening 14 provided below the exit-tube hole 18, a filter 16 provided inside the nozzle body 12 close to the opening 14, and an exhaust hole 20 provided above the filter 16.

The exit-tube hole 18 is used for inserting the downstream tip of the exit-tube 246 from the outlet of the backpressure control valve 216 shown in FIG. 1 into the nozzle body 12 to secure it. Among the fluid supplied from the exit-tube 246, a gaseous component fills the space defined by the nozzle body 12 above the filter 16 as well as the filter 16 itself, and the pressure inside the nozzle body 12 thus increases. The gaseous component is vented at a predetermined speed through the exhaust hole 20, which regulates the pressure. The liquid component in the fluid supplied to the nozzle body 12 from the exit-tube 246 passes through the filter 16 and is discharged outside the nozzle body 12 from the opening 14 positioned below the filter 16.

In FIGS. 2A and 2B, the nozzle body 12 is formed of a substantially tube-shaped container 12b which is shaped so that one end gradually tapers, and a stopper 12a for sealing the other end. The exhaust hole 20 and the exit-tube hole 18 are provided in this stopper 12a. The stopper 12a may be made of rubber, plastic, a metal such as stainless steel, or other materials. Glass wool is used as the filter 16. The present invention, however, is not limited to the embodiment described above; various modifications are possible so long as they achieve the objects of the present invention. For example, the container 12b may have a cylindrical shape with both ends having substantially the same diameter, or the container 12b and the stopper 12a may be integrated.

When the nozzle 10 is fitted to the exit-tube 246 from the apparatus, as shown in FIG. 2B, the downstream tip of the exit-tube from the apparatus is inserted into the exit-tube hole 18 and is secured so that the surface at the downstream tip of the exit-tube is almost in contact with the filter 16. That is, the downstream tip of the exit-tube from the apparatus is surrounded by the nozzle body 12. Also, the inside surface of the exit-tube hole 18 and the outside surface of the exit-tube 246 are in substantially airtight contact. Alternatively, the exit-tube may be secured by means of a setscrew or a ferrule.

A porous material, a woven material formed of fine fibers, fine powder, a mesh-like material, or a set of layers of the mesh-like material may be used as the filter 16. For example, it is possible to use glass wool, sintered metal, minute metallic spheres, a fine metallic mesh, and polymer or silica gel powder sandwiched by filters. That is, an object having fine flow channels which allow the liquid component to permeate the filter and reach the opening, with an effective surface area large enough to sufficiently trap the liquid component flowing from the exit-tube needs to be used.

It is preferable to provide an exhaust-level regulator 22 for regulating the amount of gas vented through the exhaust hole 20. In other words, by providing a mechanism that can change the level of resistance in the exhaust hole 20, it is possible to provide suitable pressure conditions inside the nozzle 10, even when the flow rate is changed. For example, it is possible to regulate the exhaust rate of gas by allowing the diameter of the opening for the flowing gas to be adjusted.

The above description is an outline of the configuration of the nozzle 10 for collecting extracted material according to the fist embodiment of the present invention; the operation of this nozzle will be described below.

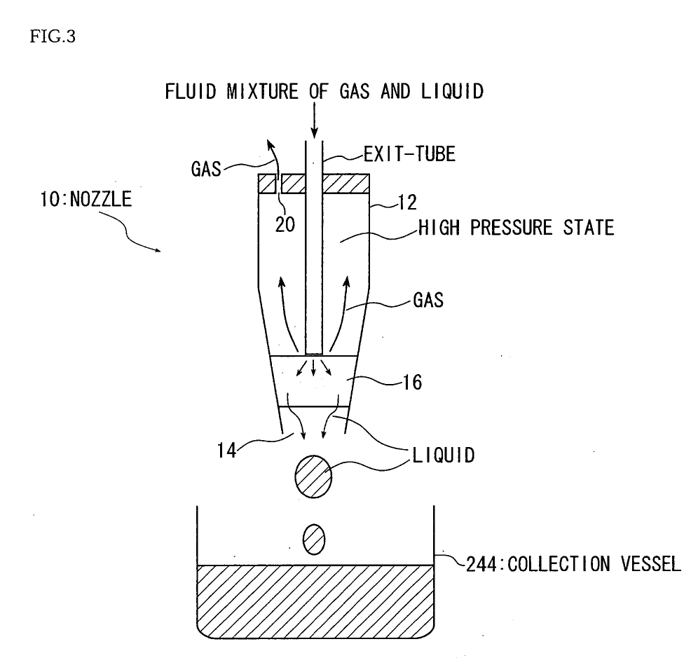

As shown in FIG. 3, when the fluid discharged from the exit-tube is sprayed into the filter 16, since the nozzle is at normal temperature and pressure, the supercritical or liquid-phase carbon dioxide in the fluid is vaporized, and liquid components such as the extracted material and entrainer are absorbed in the filter 16, where liquefaction is promoted. At this time, the space inside the nozzle body 12 above the filter 16 becomes slightly pressurized (1 to 10 MPa) due to the vaporized carbon dioxide. In other words, the liquid can be prevented from being splashed for two reasons, namely, separation of the gas and liquid components by the filter 16 and pressurization due to the vaporized carbon dioxide. Furthermore, by almost contacting the downstream tip of the exit-tube with the filter 16, the liquid component in the fluid discharged from the end of the exit-tube can be efficiently sprayed into the filter 16.

Since the pressure in the space defined by the filter 16 and the nozzle body 12 above the filter 16 (in other words, of the space inside the nozzle body 12 which is separated by the filter 16, the space opposite the side where the opening 14 is located) is high, the liquid component (entrainer, extracted material, etc.) passes through the filter 16 and is forced out of the opening 14 and thus flows outside the nozzle body 12. This component calmly drips in the liquid state from the opening 14 at the nozzle tip and is collected in the collection vessel 244 disposed below the nozzle 10. Also, in order to maintain suitable pressure conditions inside the nozzle 12, carbon dioxide gas is vented from the exhaust hole 20 provided above the filter 16.

Therefore, with the nozzle 10 for collecting extracted material according to this embodiment, it is possible to allow only the liquid component to drip out calmly, in the same way as in high performance liquid chromatography (HPLC), unlike the conventional technology where liquid and gas are sprayed from the exit-tube and are splashed.

Since the pressure inside the nozzle 10 can be maintained high, the liquid component is made to flow downwards and to be calmly forced out. Therefore, there is rarely any contamination due to mixing of components inside the nozzle body 12.

In addition, because the nozzle 10 according to this embodiment is small and lightweight, it can be attached to conventional HPLC fraction collectors. This is advantageous because the functions of the HPLC fraction collectors, such as separation based on a certain time schedule and identifying components from a chromatogram based on detected signals, can be used.

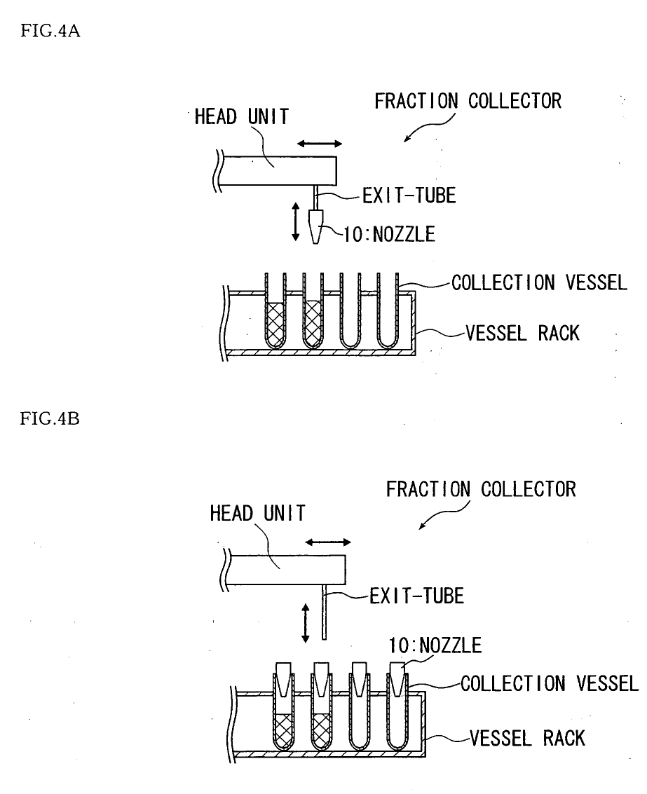

FIGS. 4A and 4B show a case where the nozzle 10 according to this embodiment is used in a fraction collector. A plurality of collection vessels are arranged in a line in a vessel rack, the exit-tube from the apparatus is supported by a head unit, and the head unit is configured so that it can move to the positions of the individual collection vessels. As shown in FIG. 4A, the nozzle 10 can be attached in advance to the exit-tube from the apparatus and moved together with the head unit to each collection vessel. Alternatively, as shown in FIG. 4B, the nozzle 10 may be fixed in advance at the top of each collection vessel, and only the exit-tube from the apparatus is moved and then inserted into the exit-tube holes in the nozzles 10 when sorting and separating the extracted liquids.

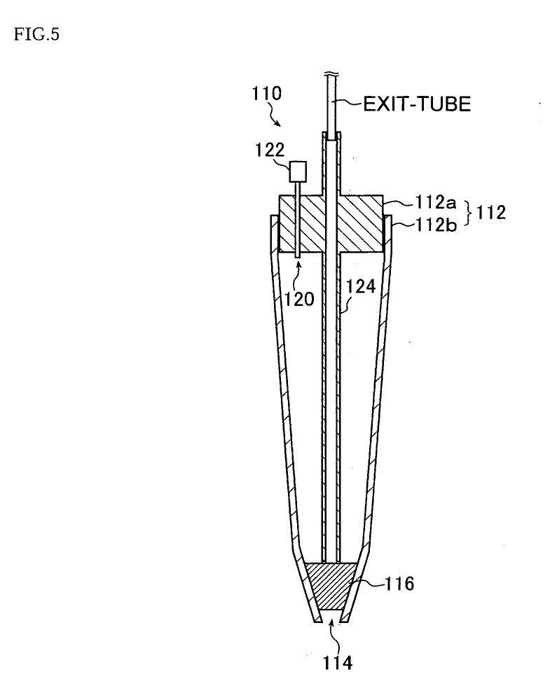

FIG. 5 is a partial cross-section of a nozzle for collecting extracted material according to a second embodiment of the present invention. Portions corresponding to those shown in FIGS. 2A and 2B have numbers obtained by adding 100 to those indicated in FIGS. 2A and 2B, and a detailed description thereof is omitted. A nozzle 110 for collecting extracted material in FIG. 5 includes a nozzle body 112 defining a space of predetermined volume, an entry tube 124 provided in the nozzle body 112, an opening 114 provided below the downstream tip of the entry tube 124, a filter 116 provided between the downstream tip of the entry tube 124 and the opening 114, and an exhaust hole 120 provided above the filter 116. The filter 116 is disposed so as to be almost in contact with the downstream tip of the entry tube 124.

The entry tube 124 in the nozzle body 112 is configured so that the upstream (upper) end thereof can be connected to the downstream tip of the exit-tube from the apparatus and is provided for introducing the fluid supplied from the exit-tube into the nozzle body 112. In other words, unlike the first embodiment shown in FIGS. 2A and 2B, where the exit-tube from the apparatus is directly inserted into the connected nozzle, in the second embodiment shown in FIG. 5, a flow path for introducing the fluid supplied from the exit-tube into the nozzle body 112 is provided in advance in the nozzle body 112. In such a case, it is necessary to ensure a substantially airtight seal at the connection part between the entry tube 124 and the exit-tube from the apparatus.

Furthermore, in the second embodiment shown in FIG. 5, the entry tube 124 is integrally formed with a stopper 112a constituting the nozzle body 112. The structure of a container 112b is the same as that in the first embodiment shown in FIG. 2; that is, the tip of the container 112b at the opposite side from the opening 114 is sealed. An exhaust hole 120 is also provided in the stopper 112a, and the pressure in the space defined by the filter 116 and the nozzle body 112 above the filter 116 is regulated. In addition, similarly to the first embodiment shown in FIGS. 2A and 2B, an exhaust-level regulator 122 for regulating the exhaust level of gas vented through the exhaust hole 120 is preferably provided.

When the nozzle 110 is fitted, the fluid from the exit-tube is introduced into the nozzle body 112 through the entry tube 124, and the fluid is sprayed into the filter 116 from the downstream tip of the entry tube 124. Then, similarly to the operation described with reference to FIG. 3, the space enclosed by the filter 116 and the nozzle body 112 above the filter 116 is pressurized due to the gaseous component in the fluid, and the liquid component passes through the filter 116 and is discharged from the opening 114.

Although the embodiment in FIG. 5 shows an example in which the entry tube 124 and the stopper 112a of the nozzle body 112 are integrated, the entry tube 124 and the stopper 112a may be configured as separate elements. That is, a configuration in which a tube serving as the entry tube is simply inserted into the stopper and secured thereto may also be adopted. And furthermore, the container 112b and the stopper 112a may be integrated to form the nozzle body 112.

The embodiments above have been described in terms of an example in which carbon dioxide is used as the supercritical fluid, as is common. The present invention, however, is not limited to the use of carbon dioxide; for example, a material that vaporizes at normal temperature (under the collection conditions) may be employed as the supercritical fluid.

What is claimed is:

1. A nozzle for collecting extracted material, which is fitted to an end of an exit-tube at the downstream side of a backpressure control valve in a supercritical fluid chromatograph or a supercritical fluid extraction apparatus and which is used for collecting in a collection vessel a liquid component in a fluid supplied from the exit-tube, the nozzle comprising:
a nozzle body enclosing a space of predetermined volume;
an exit-tube hole provided in the nozzle body, for inserting a downstream tip of the exit-tube into the nozzle body to secure the exit-tube;
an opening provided at the lower end of the nozzle body, for discharging outside the nozzle body the liquid component in the fluid supplied from the exit-tube;
a filter provided above the opening in the nozzle body; and
an exhaust hole provided in the nozzle body at a position above the filter, for exhausting at a predetermined speed a gaseous component in the fluid supplied from the exit-tube to regulate the pressure in the space enclosed by the filter and the nozzle body above the filter;
wherein, when the nozzle is fitted, the downstream tip of the exit-tube is inserted through the exit-tube hole and is secured so that the downstream tip of the exit-tube is almost in contact with the filter; and
the fluid discharged from the exit-tube is sprayed into the filter, the space enclosed by the filter and the nozzle body above the filter is pressurized due to the gaseous component contained therein, and the liquid component passes through the filter and is discharged from the opening.

2. A nozzle for collecting extracted material according to claim 1, wherein the filter comprises a porous material, a woven-fiber filter, a mesh-like material, a set of layers of the mesh-like material, or a powdered substance.

3. A nozzle for collecting extracted material according to claim 1, wherein the filter comprises one or more material selected from the group consisting of a porous sintered metal, glass wool, a minute spherical metal, polymer or silica gel powder, and a fine mesh-like metal.

4. A nozzle for collecting extracted material according to claim 1, further comprising an exhaust-level regulator, provided in the exhaust hole, for regulating the exhaust level of the gaseous component.

5. A nozzle for collecting extracted material, which is fitted to an end of an exit-tube at the downstream side of a backpressure control valve in a supercritical fluid chromatograph or a supercritical fluid extraction apparatus and which is used for collecting in a collection vessel a liquid component from a fluid supplied by the exit-tube, the nozzle comprising:
a nozzle body enclosing a space of predetermined volume;
an entry tube provided in the nozzle body and connected to the downstream tip of the exit-tube, for introducing the fluid supplied through the exit-tube into the nozzle body;
an opening provided at the lower end of the nozzle body, for discharging outside the nozzle body the liquid component in the fluid supplied through the entry tube;
a filter provided in the nozzle body above the opening so as to be almost in contact with the downstream tip of the entry tube; and
an exhaust hole disposed above the filter, for exhausting at a predetermined speed a gaseous component in the fluid supplied through the entry tube to regulate the pressure in the space enclosed by the filter and the nozzle body above the filter;
wherein, when the nozzle is fitted, the downstream tip of the exit-tube and the upstream tip of the entry tube are connected, the fluid from the exit-tube passes through the entry tube and is sprayed into the filter, the space enclosed by the filter and the nozzle body above the filter is pressurized due to the gaseous component contained therein, and the liquid component passes through the filter and is discharged from the opening.

6. A nozzle for collecting extracted material according to claim 5, wherein the filter comprises a porous material, a woven-fiber filter, a mesh-like material, a set of layers of the mesh-like material, or a powdered substance.

7. A nozzle for collecting extracted material according to claim 5, wherein the filter comprises one or more material selected from the group consisting of a porous sintered metal, glass wool, a minute spherical metal, polymer or silica gel powder, and a fine mesh-like metal.

8. A nozzle for collecting extracted material according to claim 5, further comprising an exhaust-level regulator, provided in the exhaust hole, for regulating the exhaust level of the gaseous component.
